(19) United States
(12) Patent Application Publication
(10) Pub. No.: US 2024/0391137 A1
(43) Pub. Date: Nov. 28, 2024

(54) DECORATION METHOD AND SYSTEM FOR THE DECORATION OF A BASE CERAMIC ARTICLE

(71) Applicant: SACMI COOPERATIVA MECCANICI IMOLA SOCIETA' COOPERATIVA, IMOLA (IT)

(72) Inventor: Angelantonio ONORATO, IMOLA (IT)

(21) Appl. No.: 18/693,907

(22) PCT Filed: Sep. 22, 2022
(86) PCT No.: PCT/IB2022/058966

§ 371 Date: Mar. 20, 2024

(30) Foreign Application Priority Data
Sep. 22, 2021 (IT) 102021000024380

(51) Int. Cl. B28B 11/04; B28B 5/02; B28B 11/00; B28B 11/06; B28B 17/00; B41M 5/00

(52) U.S. Cl. CPC B28B 11/041; B28B 5/021; B28B 11/001; B28B 11/044; B28B 11/048; B28B 11/06; B28B 17/0081; B41M 5/0047; B41M 5/007

(57) ABSTRACT

Method and system for decorating a base ceramic article (CB) having a surface to be decorated. The decoration system comprises: a first printing assembly for applying a first layer of adhesive material on at least part of the surface; a digital depositing assembly for depositing a second layer comprising granular material or enamel atomized particles on the first layer to form an at least partially relief pattern on the surface; a detection assembly of such at least partially relief pattern; a second printing assembly, operable based on the data detected by the detection assembly, to form a defined image on the at least partially relief pattern; a dryer configured to dry the base ceramic article (CB) and arranged between the digital depositing assembly and the second printing assembly; and a firing kiln.

### CROSS-REFERENCE TO RELATED APPLICATIONS

This Patent Application claims priority from Italian Patent Application No. 102021000024380 filed on Sep. 22, 2021 the entire disclosure of which is incorporated herein by reference.

### FIELD OF THE ART

The present invention relates to a decoration method and system for the surface decoration of a base ceramic article.

In particular, the present invention relates to a method and system for the decoration of slabs comprising (consisting of) ceramic material; still more particularly, of tiles comprising (consisting of) ceramic material.

### BACKGROUND OF THE INVENTION

In the field of manufacturing ceramic articles, particularly ceramic slabs and tiles, it is known to submit base ceramic articles to surface treatments adapted to give the article the desired aesthetic, mechanical and functional properties.

The most widespread surface treatments are decoration treatments adapted to give the base ceramic article the desired aesthetic appearance. In recent years, there has been a widespread tendency to try to reproduce the appearance of natural stone or wood, etc. by imprinting the base ceramic article with a three-dimensional pattern in addition to a chromatic decoration that reproduces the surface coarseness and/or irregularities and/or roughness of natural stone, wood, etc., thus giving a more natural appearance to the ceramic article.

Some known systems for decorating ceramic articles provide for imprinting a three-dimensional pattern on at least one surface of a base ceramic article during the ceramic powder pressing step. In particular, such known systems provide that at least one of the two half moulds of the pressing device intended to form the base ceramic article is configured to imprint a certain three-dimensional pattern on the surface of the base ceramic article during pressing. The base ceramic article thus formed (i.e. already having a three-dimensional pattern on a surface) is then further decorated by applying a chromatic decoration, e.g. using an inkjet printer, and is subsequently submitted to drying and firing so as to obtain a finished ceramic product.

Other known decoration systems comprise firstly pressing ceramic powder and drying the base ceramic articles and then decorating the dried ceramic article by means of a decoration device that selectively applies adhesive and granular material to a surface of the base ceramic article to form the three-dimensional pattern and a subsequent printing device that prints an image (chromatic decoration) on the three-dimensional pattern to reproduce a certain final decoration. The base ceramic article thus decorated is then fired so as to obtain a finished ceramic product.

However, the known decoration systems comprise printing an image on the base ceramic article having a certain three-dimensional pattern regardless of the actual three-dimensional structure on the article itself and/or the actual orientation of the ceramic article. This often results in base ceramic articles decorated with the known machines and methods described above having a three-dimensional pattern that does not appear to be in synchrony with the image or chromatic decoration printed on it. It is clear that this compromises the final aesthetic appearance of ceramic products.

In addition, decoration systems and methods of the known type have another technical drawback related to the fact that the adhesive material and/or ink used for creating the three-dimensional pattern and/or the chromatic decoration, warming up when in contact with the hot surface of the freshly dried base ceramic article or during the firing step, induces (induce) the emission of toxic and often bad-smelling waste products, which must be sucked and appropriately treated with expensive filtration (or abatement) systems to ensure the safety and healthiness of the environment and to comply with the environmental regulations in force.

The aim of the present invention is to provide a decoration method and system for the decoration of a base ceramic article, which allow to overcome, at least partially, the drawbacks of the prior art while being easy and cheap to implement.

### SUMMARY

In accordance with the present invention, a decoration method and system are proposed for decorating a base ceramic article as claimed in the attached independent claims, and preferably, in any one of the claims dependent directly or indirectly on the mentioned independent claims.

The claims describe preferred embodiments of the present invention forming an integral part of the present description.

### BRIEF DESCRIPTION OF THE DRAWINGS

The invention is hereinafter described with reference to the accompanying drawings, which show some non-limiting embodiments thereof, wherein:

FIG. 1 is a schematic side view of a production plant for ceramic articles in accordance with the present invention;

FIG. 2 is a schematic side view of a base ceramic article having a decoration made in accordance with the present invention;

FIG. 3 is a schematic view from above of a decorated ceramic product in accordance with the present invention; and

FIG. 4 is a perspective and schematic view of a detail of the plant of FIG. 1.

### DETAILED DESCRIPTION

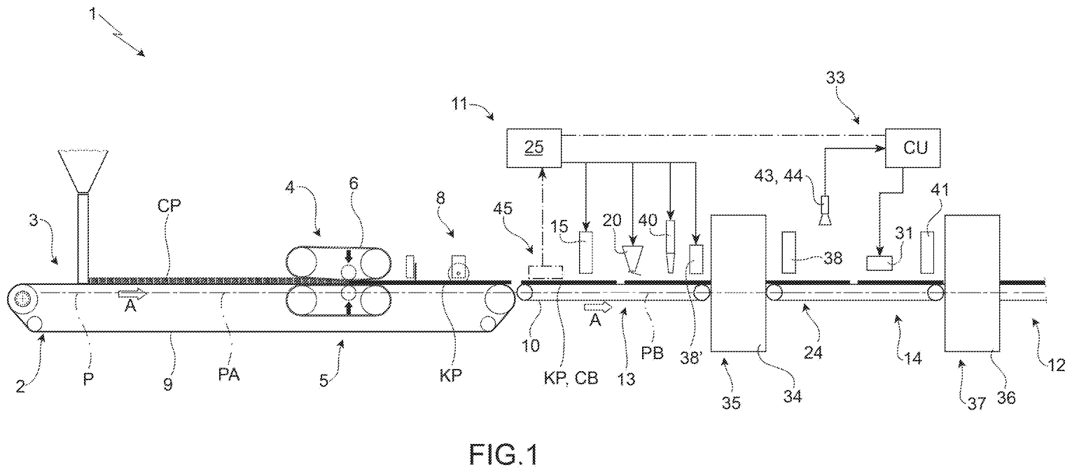

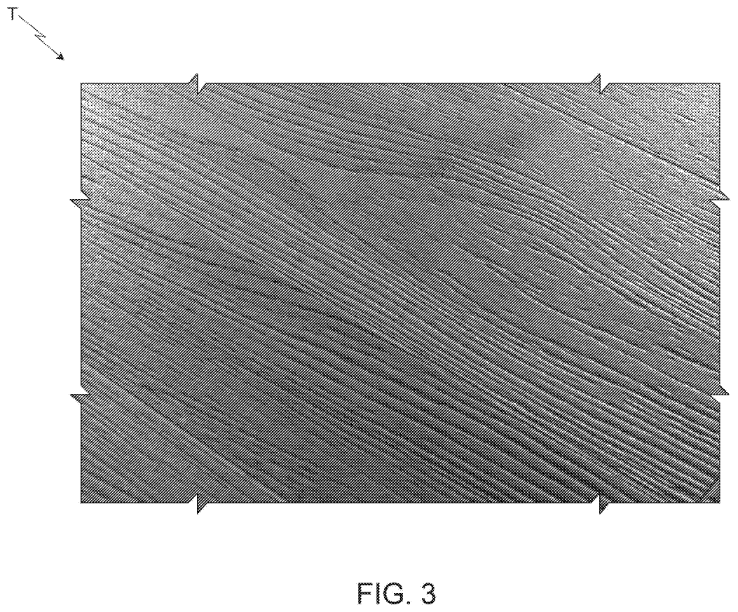

In FIG. 1 a plant for the production of a ceramic product T is globally denoted by 1. In particular, the ceramic product T is a ceramic slab (more precisely, a tile), such as the one shown in FIG. 3.

According to some preferred but not exclusive embodiments such as the one shown in FIG. 1, the plant 1 comprises a conveyor assembly 2 for moving (in a substantially continuous manner) a layer of powder material CP comprising (in particular, mainly consisting of) ceramic powder along a section PA of a given path P in a moving direction A from an inlet station 3 towards (through) a work assembly 4 which is arranged at a first work station 5 and comprises at least one compaction machine 6 configured to compact the layer of powder material CP so as to obtain at least one slab of compacted ceramic powder KP having at least one surface 7 to be decorated.

In detail, according to some non-limiting embodiments such as the one shown in FIG. 1, the compaction machine 6 is a continuous compaction machine and the plant 1 also comprises at least one cutting assembly 8 for cutting transversely to the moving direction A the slab of compacted ceramic powder KP obtained from the compaction machine 6 so as to obtain a plurality of slabs of compacted ceramic powder KP having at least one surface 7 to be decorated (i.e. a plurality of base ceramic articles CB).

In this case, advantageously but not necessarily, the conveyor assembly 2 comprises a conveyor device 9, for example comprising a belt conveyor (as in FIG. 1) or a roller conveyor, which is configured to move the slab of compacted ceramic powder KP coming out from the compaction machine 6 to the cutting assembly 8 and at least one further conveyor device 10 to move the plurality of slabs of compacted ceramic powder KP from the work station 5 towards (through) a decoration system 11 (which is part of the plant 1) for the decoration of the base ceramic article CB; even more particularly, towards an output station 12, through at least a first decoration station 13 and a second decoration station 14, arranged downstream of the first decoration station 13 along the given path P.

According to other embodiments of the invention, the plant 1 comprises a conventional tile pressing machine (of a known type) which is configured to receive a defined amount of powder material CP comprising (in particular, mainly consisting of) ceramic powder and to compact it so as to generate a slab of compacted ceramic powder KP having at least one surface 7 to be decorated at each pressing cycle; which slab of compacted ceramic powder KP is then moved, for example by means of the conveyor device 10 from the work station 5 towards (through) a decoration system 11 for the decoration of the base ceramic article CB. Typically, such a conventional pressing machine is provided with a vertical-axis hydraulic pressing device adapted to press powder ceramic material so as to directly obtain individual slabs (which do not require cutting) of pressed material.

Advantageously, in the present discussion, the term base ceramic article CB refers to at least one portion of (in particular, of each) slab of compacted ceramic powder KP having the above-mentioned surface 7 to be decorated.

Furthermore, in the present discussion, “surface 7 to be decorated” refers to the surface of (each) slab of compacted ceramic powder KP (i.e. the base ceramic article CB) that is intended, in use, to be in view (i.e. exposed); in particular, the surface 7 to be decorated is the surface facing upwards while being conveyed by the conveyor assembly 2, i.e. the surface 7 of the slab of compacted ceramic powder KP that is parallel to the conveying plane defined by the conveyor assembly 2, in particular by the conveyor device 10, but is not in contact with it during the movement along the given path P.

Advantageously, but not limitatively, the conveyor device 10 is configured to convey the (each) slab of compacted ceramic powder KP along a second section PB of the given path P, downstream of the section PA, (coming out) from the work station 5 to the output station 12, through the decoration system 11 (which is part of the plant 1); in particular, through at least the first decoration station 13 and the second decoration station 14.

According to some advantageous non-limiting embodiments such as the one shown in FIG. 1, the plant 1, in particular the decoration system 11, comprises a printing assembly 15, which is arranged at the first decoration station 13 downstream of the first work station 5 along the given path P and is configured to apply a first layer 16 comprising (in particular, consisting of) a first material 17, which comprises (in particular, is) adhesive material, on at least a part of the surface 7 to be decorated of (each of) the slab of compacted ceramic powder KP.

Advantageously but not limitatively, the adhesive material 17 is a water-based glue. Specifically, (according to some advantageous but non-limiting embodiments) it is a glue comprising (even more in particular consisting of) about 50% by weight of Glycol, about 20% by weight of Water, about 30% by weight of inorganic part. The use of a water-based adhesive material thus made reduces the risk of hazardous emissions during drying, while ensuring good adhesion of the granular material 22 that is applied on the layer 16 (as will be better described hereinafter).

Additionally, advantageously but not necessarily, the printing assembly 15 comprises an ink-jet head (ink-jet not visible in the accompanying Figures and known in itself and therefore not further described herein) configured to emit one or more jets of adhesive material 17 (selectively) onto the surface 7 to be decorated. In this case, advantageously but not necessarily, the adhesive material 17 is such (i.e. has such a texture and viscosity) that it can be applied by an ink-jet head.

In particular, according to some advantageous but not exclusive embodiments, the printing assembly 15 is configured to apply the layer 16 (in particular selectively) on the surface 7 to be decorated, at least on a defined part of the surface 7 to be decorated.

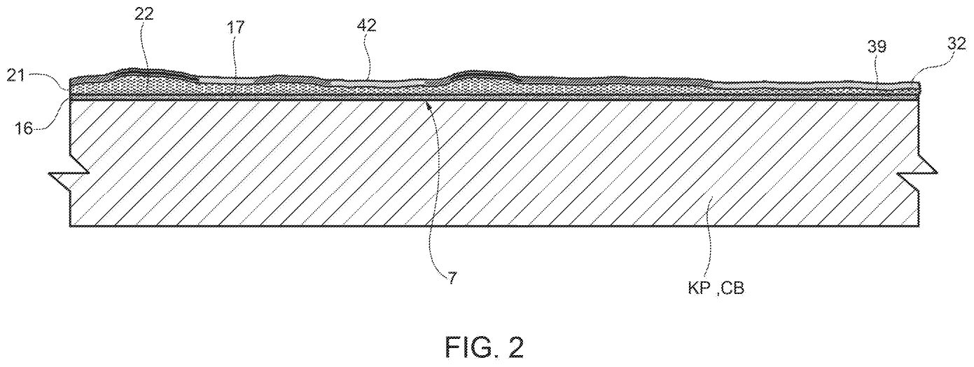

In detail, according to some advantageous but non-limiting embodiments such as the one shown in FIG. 2, the printing assembly 15 applies the layer 16 over substantially the entire extension of the surface 7 to be decorated. Alternatively, in accordance with other non-limiting and not shown variants, the defined part is such that at least one other defined part of the same surface 7 to be decorated (in particular, different from the above defined part) remains free of adhesive material 17.

According to other non-limiting and not illustrative variants, the printing assembly 15 is configured to apply (in particular, digitally) the adhesive material 17 so as to reproduce a defined pattern on the surface 7 to be decorated. In other words, the printing assembly 15 is configured to apply adhesive material 17 so that the layer 16 defines a pattern on the surface 7 to be decorated.

Advantageously, the decoration system 11 further comprises a first digital depositing assembly 20, which is arranged at the decoration station 13 downstream of the printing assembly 15 and is configured to deposit a second layer 21 comprising (in particular, consisting of) at least one first granular material 22, comprising granules and/or enamel atomized particles, selectively on the first layer 16 so as to adhere to the first layer 16 and to form an at least partially relief pattern on the surface 7 to be decorated of the (in particular, of each) slab of compacted ceramic powder KP (see for example FIG. 2).

In the present discussion, “at least partially relief pattern” refers to a three-dimensional decoration made on the surface 7 to be decorated; in particular, the “at least partially relief pattern” could comprise a succession of elevations of different shape and trend arranged to form a three-dimensional structure/decoration, for example composed of a plurality of veins, striations, motifs, etc. in order to reproduce the real appearance of natural stones, wood or in general to reproduce any three-dimensional structure. According to some preferred but not limiting embodiments such as those shown in FIG. 2, the layer 21 of granular material 22 is deposited over the entire extension of the layer 16. In particular, over the entire defined part on which the adhesive material 17 was previously (i.e. upstream along the given path P) deposited.

Alternatively, according to some advantageous but non-limiting embodiments not shown, the layer 21 of granular material 22 is selectively deposited on the layer 16 at only a portion of the aforementioned defined part of the surface 7 to be decorated so as to adhere to the layer 16 and form the aforementioned at least partially relief pattern.

More precisely, advantageously but not necessarily, the decoration system 11 also comprises a control assembly 25 (see FIG. 1) which is configured to control (in particular, digitally) the depositing assembly 20 so that it deposits the layer 21 of granular material 22 over the entire extension of the layer 16 or over a part of such layer 16.

According to some non-limiting and non-shown embodiments, the control assembly 25 is configured to control (in particular, digitally) the depositing assembly 20 to reproduce a defined pattern on the layer 16. In particular, when the layer 16 is such as to reproduce a pattern on the surface 7 to be decorated, the two patterns (the one defined by the layer 16 and the one defined by the layer 21) may coincide at least partially with each other. In these cases, the control assembly 25 is advantageously but not necessarily configured to also control the printing assembly 15. Specifically, advantageously but not necessarily, the distribution of the granular material 22 on the layer 16 may appear to be wider than the distribution of the adhesive material 17 on the surface 7 to be decorated, as it may be advantageous to deposit an amount of granular material 22 slightly in excess if compared to what is required (in order to reduce the risk that areas where the presence of the powder material 22 is appropriate remain without the required amount).

According to alternative embodiments, the distribution of the granular material 22 on the layer 16 may appear less wide than the distribution of the adhesive material 17 on the surface 7 to be decorated (in other words, the pattern defined by the layer 21 may be less wide than the pattern defined by the layer 16). In such a case, in the part of the pattern defined by the layer 16 on which the granular material 22 is not deposited, another granular material, different from the granular material 22, may, for example, be deposited in the same application step or in subsequent application steps (i.e. from the same depositing assembly 20 or from another depositing device).

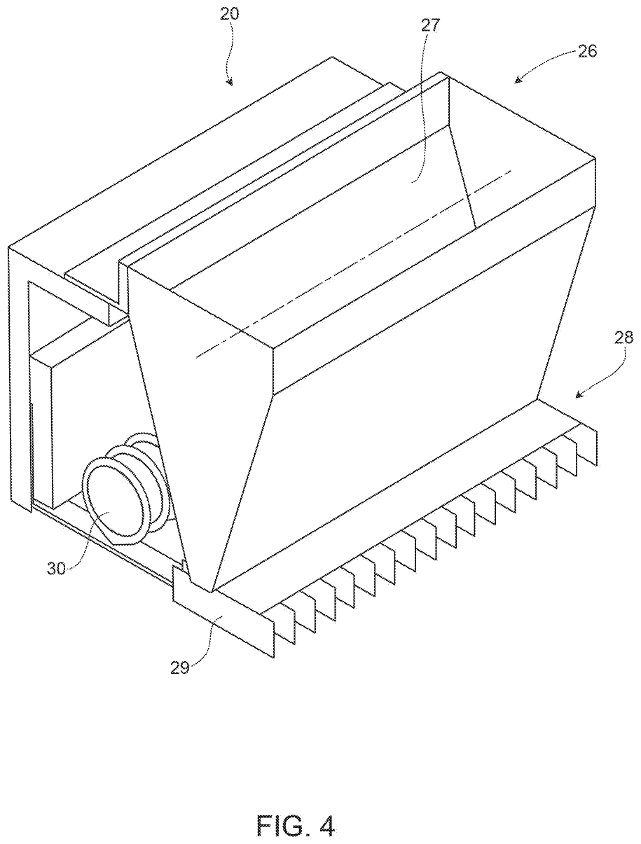

Advantageously but not necessarily, in accordance with the non-limiting embodiment shown in FIGS. 1 and 4, the depositing assembly 20 comprises at least one depositing device 26 comprising a container 27, which is configured to contain the granular material 22 and has an output mouth 28, the longitudinal extension of which is transverse (in particular, perpendicular) to the moving direction A, and a plurality of distribution elements (fingers) 29 arranged in succession along the output mouth 28 and each operable independently of the others to allow the passage of the granular material 22 through an area of the output mouth 28 wherein it is arranged.

Still more specifically, advantageously but not necessarily, the depositing device 26 comprises a plurality of actuators 30, each of which is adapted to move a respective distribution element 29 between a closed position, wherein the respective distribution element 29 blocks the passage of the granular material 22 through the area of the output mouth 28 wherein it is arranged, and an open position, wherein the respective distribution element 29 allows the passage of the granular material 22 through the area of the outlet mouth 28 wherein it is arranged.

It should be noted that by using the depositing device 26 it is possible to obtain a more precise deposition (also in terms of thickness) of the granular material 22 and thus it is possible to more precisely define the three-dimensional pattern on the surface 7 to be decorated.

According to some non-limiting embodiments, the depositing assembly 20 is made as described in Patent application WO2009118611 and/or in Patent IT1314623 (by the same Applicant).

According to some advantageous but non-limiting embodiments, the first granular material 22 comprising granules and/or enamel atomised particles comprises (in particular, consists of) material having a particle size ranging from about 50 μm to about 500 μm; more advantageously from about 90 μm to about 300 μm.

Furthermore, according to some advantageous, non-limiting and non-shown embodiments, the granular material 22 comprises a first type of granules and/or atomised particles and a second type of granules and/or atomised particles, which differs from the first type in size and/or mechanical/physical characteristics. Such different types of granules and/or atomised particles may be at least partially overlapping each other or may be arranged on different areas of the layer 16 of adhesive material 17, depending on the type of partially relief pattern to be formed. In particular, advantageously but not limitatively, the first and second types of powder material 22 differ from each other in mechanical/physical characteristics, e.g. grain size.

In such cases, advantageously but not necessarily, the depositing assembly 20 comprises two or more depositing devices 26 that are equal and placed side by side and arranged in sequence along the given path P, one intended to deposit a first type of granular material 22 and the other intended to deposit a second type of granular material 22. Alternatively, the depositing assembly 20 may comprise a single depositing device 26, such as the one described above, whose container 27 is filled with granular material 22 of the two different types in subsequent steps.

Advantageously, the decoration system 11 comprises at least one further printing assembly 31, which is arranged at the second decoration station 14 and is configured to apply a third layer 32, which comprises (in particular, consists of) an ink and/or coloured powder particles on the second layer 21 so as to form a defined image (i.e. a chromatic pattern) on the at least partially relief pattern.

According to some advantageous but non-limiting embodiments, the third layer 32 comprises (in particular, consists of) water-based ink. In detail, advantageously but not limitatively, such a water-based ink comprises at least about 20% and up to about 30% of water; in particular, about 25% of water. An example of a water-based ink comprising (in particular, constituting) the above-mentioned layer 32 comprises (in particular, consists of): from about 20% to about 30%, in particular about 30%, of inorganic solid material (e.g., coloured ceramic powder and/or ceramic frit); from about 30% to about 50%, in particular about 45%, of a medium e.g., glycol-based; and from about 20% to about 30%, in particular about 25%, of water.

Advantageously but not limitatively, such printing assembly 31 has a structure and operation similar to the printing assembly 15.

Advantageously, as shown in the non-limiting embodiment of FIG. 1, the decoration system 11 further comprises at least one detection assembly 33 arranged and configured to detect the at least partially relief pattern formed on the surface 7 to be decorated and a control assembly CU configured to actuate (i.e. control; in particular, digitally) the printing assembly 31, depending on what has been detected by the detection assembly 33, so that the further printing assembly 31 forms the defined image, arranging it with respect to the at least partially relief pattern so as to generate (together with said at least partially relief pattern) a defined (three-dimensional) decoration on the surface 7 to be decorated of the (in particular, of each) slab of compacted ceramic powder KP.

Advantageously, the plant 1 (in particular, the decoration system 11) also comprises a dryer 34 which is arranged at a second work station 35, downstream of the first decoration station 13 and upstream of the second decoration station 14 along the given path P; which dryer 34 is configured to heat the (in particular, each) slab of compacted ceramic powder KP having the above-described at least partially relief pattern to a temperature of at least about 100° C. (in particular, of at least about 150° C.; even more particularly, to at least about 180° C.).

Furthermore, advantageously (as shown in the non-limiting embodiment of FIG. 1), the system 1 (in particular, the decoration system 11) comprises (also) a kiln 36 arranged at the third work station 37 downstream of the second decoration station 14 along the given path P to sinter the (each) slab of compacted ceramic powder KP (i.e., each base ceramic article CB) so as to obtain a ceramic product T. In particular, advantageously but not necessarily, the kiln 36 is configured to impose a temperature ranging from at least about 1000° C. to at least about 1300° C. (in particular, from at least about 1150° C. to at least about 1250° C.) on said at least one (in particular, each) slab of compacted ceramic powder (KP) so as to fire it.

According to some advantageous but non-limiting embodiments of the invention, the decoration system 11 also comprises at least another printing assembly 38 which is arranged downstream of the decoration station 13 and upstream of the second decoration station 14 and applies a fourth layer 39 comprising (in particular, consisting of) a fourth material, which comprises (in particular, consisting of) a coating material, in particular a liquid enamel or engobe, on the second layer 21.

This additional layer 39 makes it possible to even out the surface 7 to be decorated after creating the at least partially relief pattern and at the same time to reduce the risk of the granular material 22 moving on the slab of compacted ceramic powder KP, e.g. in the subsequent decoration steps, compromising the aesthetic appearance of the decoration.

Advantageously, but not limitatively (as in the non-limiting embodiment shown in FIG. 1), the printing assembly 38 is arranged immediately downstream of the dryer 34 and immediately upstream of the printing assembly 31 and comprises an airless booth for applying the aforementioned fourth layer 39 of material comprising (in particular, consisting of) enamel/engobe (i.e., liquid enamel) so as to even out the surface 7 to be decorated. The arrangement of the printing assembly 38 beyond the dryer 34 prevents the risk of generating and emitting toxic substances as a result of the enamel/engobe during being warmed up during drying. In addition, advantageously, the application of enamel/engobe ensures a higher print quality of inkjet colours. The chromatic decoration is also more uniform after the application of the layer 39 and is not affected by the influence of the granular material 22 applied by the depositing assembly 20.

According to other advantageous but non-limiting embodiments, the printing assembly 38 has a structure and operation similar to the printing assembly 15 and printing assembly 31.

According to other advantageous but non-limiting embodiments not shown, the printing assembly 38′ is arranged immediately downstream of the depositing assembly 20 and immediately upstream of the dryer 34. In other words, the fourth layer 39 of material comprising enamel/engobe may be applied at the first decoration station 13. Alternatively, such additional printing assembly 38′ could apply a white ink instead of enamel/engobe.

Alternatively or in combination, advantageously but not limitatively, the decoration system 11 could comprise a printing assembly 38 arranged immediately downstream of the dryer 34 and a further printing assembly 38′ (similar to the printing assembly 38) arranged immediately downstream of the depositing assembly 20 and immediately upstream of the dryer 34 (as shown in FIG. 1).

According to still other embodiments, the depositing assembly 20 could be configured to deposit (also) a layer 39 of material comprising (in particular, consisting of) white ink, which (advantageously but not limitatively) could replace the aforementioned enamel/engobe.

According to some advantageous but non-limiting and non-shown embodiments, the decoration system 11 comprises a further printing assembly (not shown and having the same structure and same operation as the printing assembly 15) arranged downstream of the depositing assembly 20 and configured to apply another layer comprising (in particular, consisting of) adhesive material on the layer 21 of granular material 22. Such an additional layer would be useful to ensure that any granular material 22 that had not adhered to the underlying layer 16 is blocked, thus minimising the risk of undesirable movement of granular material 22 that could soil components of the decoration system 11 or compromise the at least partially relief pattern. Alternatively, such an additional layer of adhesive material could receive additional granular material 22 by an additional depositing assembly (advantageously similar to the depositing assembly 20). In other words, as mentioned above, the at least partially relief pattern could be formed by several layers of adhesive material 17 and granular material 22 arranged in succession on the surface 7 to be decorated by several printing and depositing assemblies, advantageously digital, arranged in sequence along the given path P.

According to further advantageous but non-limiting embodiments such as those shown in FIG. 1, the decoration system 11 comprises a removal device 40 (known in itself), advantageously arranged at the first decoration station 13 downstream of the depositing assembly 20 along the given path P, and configured to remove, preferably by suction, exceeding granular material 22, in particular granular material 22 not adhered to the layer 16 (as shown for example in FIG. 1).

More precisely, according to some non-limiting embodiments, such a removal device 40 comprises a suction mouth designed to suck upwards the granular material 22 not adhered to the layer 16. Alternatively, the removal device 40 could be configured to remove the excess granular material 22 by blowing.

It is to be understood that the decoration system 11 may comprise any number of depositing and printing assemblies, and possibly removal devices, made according to any one of the embodiments described above, arranged in sequence so as to produce a partially multilayer relief pattern on the surface 7 to be decorated.

Furthermore, according to some advantageous but non-limiting embodiments not shown, the decoration system 11 comprises a final printing assembly 41 arranged downstream of the printing assembly 31, even more advantageously upstream of the kiln 36, along the given path P and configured to apply a final layer 42 comprising (in particular, consisting of) a coating material comprising (in particular, consisting of) a liquid enamel or engobe, on the layer 32 to cover it, in particular on the given decoration formed on the surface 7 to be decorated to cover it.

Advantageously, the coating material of the layer 42 may be any material, e.g., a fixative material, or a material such as to provide the surface 7 to be decorated with special aesthetic properties (e.g., special gloss) and/or functional properties (e.g., special roughness).

According to some advantageous but non-limiting embodiments such as the one shown in FIG. 1, the detection assembly 33 is arranged immediately downstream of the dryer 34 along the given path P and comprises: a first position detector 43 (schematically shown in FIG. 1) for detecting the position (i.e., the orientation) of the (in particular, of each) slab of compacted ceramic powder KP with respect to the moving direction A at (i.e., entering) the second decoration station 14; and a structure detection device 44 (schematically shown in FIG. 1) configured to detect (i.e., identify) the structure (in particular, the shape and/or trend and/or contours and/or size) of the at least partially relief pattern formed on the surface 7 to be decorated.

In detail, according to some advantageous but non-limiting embodiments, the structure detection device 44 comprises (in particular, consists of) a vision device, e.g. a camera or laser scanner. It is understood that any detection device that allows to identify the at least partially relief pattern could be used.

Alternatively or additionally, the detection assembly 33 further comprises at least one positioning device (i.e., centring device) known in itself and not shown that is configured to move the (in particular, each) slab of compacted ceramic powder KP with respect to the moving direction A and the control assembly CU is configured to control the positioning device (i.e., centring device) depending on what is detected by the first position detector 43 so that at least one (in particular, each) slab of compacted ceramic powder KP assumes a given position (orientation) with respect to the moving direction A. In detail, advantageously but not limitatively, the control assembly CU is configured to control the positioning device (i.e., centring device) so that it centres the (each) slab of compacted ceramic powder KP with respect to the moving direction A entering the second decoration station 14.

In detail, according to some advantageous though non-limiting embodiments, the positioning (i.e., centring) device comprises a plurality of movable barriers configured to act on the (in particular on each) slab of compacted ceramic powder KP, such as along the side edges of the (in particular, of each) slab of compacted ceramic powder KP and vary the orientation thereof with respect to the moving direction A. It is understood that any other positioning device of the known type may be used for the same aim.

Alternatively, advantageously but not limitatively, the data detected (i.e. collected) by the positioning (i.e. centring) device are also used by the control assembly CU to control the printing assembly 31.

According to still other non-limiting embodiments such as that schematically shown in FIG. 1, the decoration system 11 comprises at least a second detection assembly 45 arranged upstream of the first decoration station 13 along the given path P, which detection assembly 45, in turn comprises a second position detector arranged upstream of the first decorating station 13 along the given path P and configured to detect a position (i.e., an orientation) of the (in particular, of each) slab of compacted ceramic powder KP at (i.e., entering) the first decoration station 13 with respect to the moving direction A. In this case according to some embodiments, the detection assembly 45 also comprises a further positioning device (i.e. centring device), advantageously similar to the previous one, configured to move the (in particular, each) slab of compacted ceramic powder KP with respect to the moving direction A under the action of the control assembly CU configured to control such further positioning device (i.e., centring device) according to what is detected by the further position detector so that the (in particular, each) slab of compacted ceramic powder KP assumes a given position (orientation) with respect to the moving direction A.

Alternatively, advantageously but not limitatively, the data detected (i.e. collected) by the additional position detector are also used by the control assembly CU to control the printing assembly 15 and the depositing assembly 20 via the control assembly 25. In detail, in this case, the control assembly CU exchanges data with control assembly 25, which according to some embodiments is part of the control assembly CU and according to other embodiments coincides with the control assembly CU (i.e. there is only one control assembly that controls both the printing assembly 31 as well as the printing assembly 15 and depositing assembly 20).

According to some advantageous but non-limiting embodiments, the decoration system 11 comprises a writing device (known in itself and not further described or shown herein) arranged downstream of the first decoration station 13 and configured to associate an identification code (in particular, a barcode or QRcode) to (in particular, to each) slab of compacted ceramic powder KP; and a reading device (known in itself and not further described or shown herein) that reads the identification code related to the (in particular, with each) slab of compacted ceramic powder KP to identify it. In this case, the control assembly CU is configured to operate (i.e. control; in particular digitally) the printing assembly 31, based (also) on what is detected by the reading device.

More precisely, when present, the writing device is advantageously but not limitatively arranged upstream of the first decoration station 13 along the given path P (and even more advantageously it is part of the second detection assembly 45), while the reading device is arranged (immediately) upstream of the second decoration station 14 (and still more advantageously is part of the detection assembly 33).

Due to the presence of the writing device and the reading device, advantageously but not limitatively, the control assembly CU operates the printing assembly 31 not only based at least on what is detected by the detection assembly 33 (in particular, by the first structure detecting device 45), but also based on the identification code read by the reading device.

In accordance with a further aspect of the present invention, there is also provided a decoration method for decorating a ceramic article CB having at least the surface 7 to be decorated.

Advantageously, the method comprises: a first processing step during which a layer of powder material CP comprising (in particular, consisting of) ceramic powder is processed by a work assembly 4, which is advantageously arranged at a work station 5 and comprises at least one compaction machine 6 (advantageously made according to one of the variants described above and) configured to compact the layer of powder material CP so as to obtain at least one slab of compacted powder KP having at least one surface 7 to be decorated, which is intended, in use, to be in view, i.e. exposed (as better explained above with reference to the decoration system 11).

The method further comprises: an moving step, during which the (in particular, each) slab of compacted ceramic powder KP is moved by a conveyor assembly 2 (of the type described above), in particular by a conveyor device 10, along a given path P in a moving direction A from (exiting) the work station 5 to an output station 12, through at least a first decoration station 13 and a second decoration station 14 arranged downstream of the first decoration station 13; a first application step, during which a first printing assembly 15 (advantageously of the type described above) arranged at the first decoration station 13 applies a first layer 16 comprising (in particular, consisting of) a material 17, which comprises (in particular, is) an adhesive material, in correspondence with at least a part of the surface 7 to be decorated of the (in particular, of each) slab of compacted ceramic powder KP; and at least a second application step, at least partially subsequent to the first application step, during which at least a first digital depositing assembly 20 of the type described above, arranged at the first decoration station 13 downstream of the printing assembly 15 along said given path P, deposits at least a second layer 21 comprising (in particular, consisting of) at least one granular material 22, comprising granules and/or enamel atomized particles, selectively on the first layer 16 so as to adhere to the first layer 16 and to form an at least partially relief pattern (of the type described above) on the surface 7 to be decorated.

As mentioned above in relation to the decoration system 11, according to some advantageous but non-limiting embodiments, the first granular material 22 comprising granules and/or enamel atomised particles comprises (in particular, consists of) material having a particle size ranging from about 50 μm to about 500 μm; more advantageously from about 90 μm to about 300 μm

In detail, in accordance with the non-limiting embodiment shown in FIGS. 1 and 4, the depositing assembly 20 comprises at least one depositing device 26 comprising a container 27, which is configured to contain the granular material 22 and has an output mouth 28, the longitudinal extension of which is transverse (in particular, perpendicular) to the moving direction A, and a plurality of distribution elements (fingers) 29 arranged in succession along the output mouth 28 and each operable independently of the others (by means of actuators 30, as better described above) to allow the passage of granular material 22 through an area of the output mouth 28 wherein it is arranged.
As already mentioned in relation to the decoration system 11, during the first application step, the printing assembly 15 may apply the layer 16 at the entire surface 7 to be decorated or at a portion of the surface 7 to be decorated; and during the second application step, the depositing assembly 20 deposits the layer 21 comprising the (in particular, consisting of the) granular material 22 selectively on the layer 16 in correspondence of at least a portion of said part so as to adhere to the layer 16 and define the above-described at least partially relief pattern on the surface 7 to be decorated.
Moreover, as already mentioned in relation to the decoration system 11, the method may comprise several successive application steps, during which further printing assemblies apply further layers of adhesive material 17 and further depositing assemblies deposit further granular material 22 on the previously laid layers of adhesive material to form the at least partially relief pattern.
The method further comprises a drying step, subsequent to the first and second application steps, during which the slab of compacted ceramic powder KP is dried within a dryer 34 arranged at a second work station 35, downstream of the first decoration station 13 along the given path P and at least a third application step, during which a second printing assembly 31, arranged at a second decoration station 14 downstream of the second work station 35, applies a third layer 32 comprising (in particular, consisting of) a second material, which comprises (in particular, consists of) at least one ink and/or coloured powder on the second layer 21 so as to form a defined image on the at least partially relief pattern formed in the second application step.
As mentioned above in relation to the decoration system 11, according to some advantageous but non-limiting embodiments, the third layer 32 comprises (in particular, consists of) water-based ink. In detail, such a water-based ink (which advantageously but not limitatively may be like the one described above as an example) comprises at least about 20% and up to about 30% of water, in particular about 25% of water.
Advantageously, but not limitatively, during the drying step, the (in particular, each) slab of compacted ceramic powder KP having the at least partially relief pattern described above is heated in relief to a temperature of at least about 100° C. (in particular, of at least about 150° C.; even more particularly, to a temperature of at least about 180° C.).
In detail, advantageously but not limitatively, the method also comprises a first detection step, at least partially subsequent to the second application step, during which at least one detection assembly 33 (advantageously of the type described above) detects the at least partially relief pattern formed on the surface 7 to be decorated during the second application step; and a synchronization step, at least partially simultaneous with the third application step, during which the second printing assembly 31 is operated (controlled), advantageously by a control assembly CU (of the type described above) based on what was detected in the aforementioned detection step so that the defined image is arranged with respect to the at least partially relief pattern so as to generate together with said pattern a defined decoration.
The method then comprises a firing step, during which the (in particular, each) slab of compacted ceramic powder KP having the defined decoration on the surface to be decorated is fired in a kiln 36 arranged at a third work station 37 downstream of the second decoration station 18 so as to obtain a finished ceramic product T.
More in detail, advantageously but not limitatively, the first detection step is subsequent to the drying step and at least partially preceding the third application step and comprises a position detection sub-step, during which a first position detector 43 (advantageously of the type described above) detects the position (i.e. the orientation) of the slab of compacted ceramic powder KP entering the second decoration station 14 with respect to the moving direction A, and a structure detection sub-step, during which a structure detection device 44 (advantageously of the type described above) detects the structure (in particular, the shape and/or the trend and/or the contours and/or the size) of the at least partially relief pattern formed on the surface 7 to be decorated during the first decoration step.
Alternatively or additionally, the first detection step also comprises at least one positioning sub-step, subsequent to the position detection sub-step, during which a first positioning/centring device (not shown and advantageously of the type described above) moves the (in particular, each) slab of compacted ceramic powder KP entering the second decorating station 14 so that the (in particular, each) slab of compacted ceramic powder KP assumes a given position (orientation) with respect to the moving direction A at the second decoration station 14 (in particular, so as to centre the slab of compacted ceramic powder KP with respect to the moving direction A).
Furthermore, according to some advantageous but non-limiting embodiments of the invention, the method also comprises a second detection step prior to the first application step, during which a second detection assembly 45 comprising a second position detector detects at least one position (i.e. orientation) of the slab of compacted ceramic powder KP entering the first decoration station 13 with respect to the moving direction A. In detail, advantageously but not limitatively, the second detection step also comprises a second positioning sub-step, during which a second positioning device (i.e., a centring device, similar to the previous one, and described above with reference to the decoration system 11) moves the (in particular, each) slab of compacted ceramic powder KP as it enters the first decoration station 13 so that the (in particular, each) slab of compacted ceramic powder KP assumes a given position (orientation) with respect to the moving direction A at the first decoration station 13 (in particular, so as to centre the/each slab of compacted ceramic powder KP with respect to the moving direction A).
According to some advantageous but non-limiting embodiments such as the one shown in FIG. 1, during the moving step, a plurality of slabs of compacted ceramic powder KP are moved along said given path P in the moving direction A (coming out) from the work station 5 to the output station 12. In this case, advantageously but not limitatively, the method comprises a coding step, prior to the drying step (in particular, also prior to the first and second application steps), during which a writing device (of a known type and not further herein described nor shown) associates an identification code (in particular, a barcode or QRcode) to each slab of compacted ceramic powder KP, and an identification step, at least partially preceding the synchronisation step (in particular, simultaneous with said detection step), during which a reading device (of a known type and herein neither further described nor shown) reads the identification code associated with each slab of compacted ceramic powder (KP) and identifies it. In this case, during the synchronisation step, the control assembly CU operates (controls) the second printing assembly 31 (also) based on the identification code read by the above-mentioned reading device during the identification step. According to some advantageous but not exclusive embodiments, the method comprises a further application step, subsequent to the second application step and preceding the third application step, during which a third printing assembly 38 applies a fourth layer 39 comprising (in particular, consisting of) a fourth material, which comprises (in particular, consisting of) a coating material, in particular a liquid enamel or engobe, on said second layer 21. In this case, advantageously, the moving step provides for moving the (in particular, each) slab of compacted ceramic powder KP also through a third application station 24, arranged upstream of the second decoration station 14 along said given path P. More in detail, as mentioned above in relation to the decoration system 11, such further application step may be immediately before the drying step or immediately after the drying step but prior to the third application step.
Alternatively or in addition to the foregoing, according to some embodiments, the method also comprises a final application step entirely similar to one between the first and third application steps described above and subsequent to the third application step, during which a fourth printing assembly 41, arranged downstream of the second printing assembly 31 along the given path P, applies a final layer 42, comprising (in particular, consisting of) a coating material, on the layer 32 to cover it, in particular on the given decoration formed on the surface 7 to be decorated to cover it.
According to some advantageous but non-limiting variants such as the one shown in FIG. 1, the method also comprises a removal step, subsequent to the second application step and preceding the drying step, during which a removal device 40 (known in itself), advantageously arranged at the first decoration station 13 downstream of the depositing assembly 20 along the given path P, removes, preferably by suction, the exceeding granular material 22, in particular the granular material 22 not adhered to the layer 16.
Advantageously, but not necessarily, the method is implemented by the decoration system 11 described above, so all the considerations set out above regarding possible operation variants of the decoration system 11 also apply to the method for decorating the base ceramic article BC. It is further understood that the steps of the method of the present invention (carried out according to any one of the above-described embodiments) can be repeated a finite number of times so as to achieve the desired decoration, in particular, it is possible to create an at least partially relief multilayer pattern on the surface 7 to be decorated, as well as it is possible to overlay several images on the at least partially relief pattern so as to generate the desired decoration.
The object of the present invention has several advantages if compared to the state of the art. These include the following ones.
By providing for the creation of the at least partially relief pattern in a decoration station 13 arranged upstream of the dryer 34, the present invention implies that at least the first printing assembly 15 and the depositing assembly 20 act to create such pattern on a “cold” slab (i.e., at room temperature) of compacted ceramic powder KP with considerable advantages on the final result. In fact, the forming the partially relief pattern on a “cold” surface (as opposed to the prior art which provides for decoration after drying) eliminates the risk of evaporation of part of the adhesive material 17 in contact with the hot surface 7 to be decorated which could compromise the final aesthetic appearance of the ceramic product T. Furthermore, the arrangement of the printing assembly 31 after the dryer 34, will allow the image (i.e. the chromatic decoration) to be realised on a partially relief pattern already dried and therefore more resistant and having the previously applied adhesive material 17 already crystallised (i.e. solidified), with obvious advantages in terms of ease of printing but above all in terms of quality of the final decoration obtained.
In addition, the arrangement of the first decoration station 13 upstream of the dryer 34 makes it possible to partially remove during the drying step a part of the harmful organic substances that make up the adhesive material 17, which reduces the waste substances produced during firing.

1.-15. (canceled)

16. A decoration method to decorate a base ceramic articles (CB), wherein the decoration method comprises:
a first processing step, during which a work assembly comprising at least one compaction machine processes a layer of powder material (CP) comprising (in particular, consisting of) ceramic powder so as to obtain at least one slab of compacted ceramic powder (KP) (in particular, a plurality of slabs of compacted ceramic powder (KP), each) having at least one surface to be decorated;
a moving step, during which said at least one (in particular, each) slab of compacted ceramic powder (KP) is moved along a given path (P) in a moving direction (A) (coming out) from said first workstation up to an output station, through at least a first decoration station and a second decoration station;
a first application step, during which a first printing assembly arranged at said first decoration station applies a first layer comprising (in particular, consisting of) a first material, which comprises (in particular, is) an adhesive material, in the area of at least part of said surface to be decorated of said at least one (in particular, each) slab of compacted ceramic powder (KP);
at least one second application step, which is at least partially subsequent to said first application step and during which at least one first digital depositing assembly, which is arranged at said first decoration station downstream of said printing assembly along said given path (P), selectively deposits at least one second layer comprising (in particular, consisting of) a least one granular material, which comprises granules and/or enamel atomized particles, on said first layer so that it adheres to said first layer and so as to form an at least partially relief pattern on said surface to be decorated;
said at least one first depositing assembly comprising at least one container, which is configured to contain said granular material and has an output mouth, whose longitudinal extension is transverse (in particular, perpendicular) to the moving direction (A), and a plurality of distribution elements, which are arranged in succession along the output mouth and can each be operated independently of the other ones so as to allow the granular material to go through at least an area of the output mouth where it is arranged;
a drying step, which is subsequent to said first application step and said second application step and during which said at least one slab of compacted ceramic powder (KP) is dried inside a dryer arranged at a second workstation, downstream of said first decoration station along said given path (P);
at least one third application step, during which a second printing assembly, which is arranged at a second decoration station downstream of said second workstation, applies a third layer comprising (in particular, consisting of) a second material, which comprises (in particular, consists of) at least one ink and/or colored powder, on said second layer so as to form a defined image on said at least partially relief pattern;
a first detection step, which is at least partially subsequent to said second application step and during which at least one detection assembly detects at least said at least partially relief pattern formed on said surface to be decorated during said second application step;
a synchronization step, which is at least partially simultaneous with said third application step and during which said second printing assembly is operated (controlled), based on the data detected during said first detection step, so that said defined image is arranged, relative to said at least partially relief pattern, so as to generate, together with said at least partially relief pattern, a defined decoration; and
a firing step, during which said at least one (in particular, each) slab of compacted ceramic powder (KP) having the defined decoration on said surface to be decorated is fired in a firing kiln arranged at of a third workstation downstream of said second decoration station.

17. The decoration method according to claim 16, wherein:
during said moving step, said at least one (in particular, each) slab of compacted ceramic powder (KP) is (also) moved through a third application station, which is arranged upstream of the second decoration station along said given path (P); and
the method comprises a fourth application step, which is subsequent to said second application step and prior to said third application step and during which a third printing assembly (38, 38′) applies a fourth layer comprising (in particular, consisting of) a fourth material, which comprises (in particular, consists of) a coating material, in particular a liquid enamel or engobe, on said second layer.

18. The decoration method according to claim 17, wherein said fourth application step is subsequent to said drying step.

19. The decoration method according to claim 16, wherein said first detection step is subsequent to said drying step and at least partially prior to said third application step and comprises:
a position detection sub-step, during which a first position detector detects the position (namely, the orientation) of said at least one slab of compacted ceramic powder (KP) going into said second decoration station relative to the moving direction (A), and
a structure detection sub-step, during which a structure detection device detects the structure of said at least partially relief pattern formed on said surface to be decorated during said first decoration step.

20. The decoration method according to claim 19, wherein said first detection step comprises at least one positioning sub-step, which is subsequent to said position detection sub-step and during which a first positioning device moves said at least one (in particular, each) slab of compacted ceramic powder (KP) going into said second decoration station so that said at least one (in particular, each) slab of compacted ceramic powder (KP) assumes a given position (orientation) relative to the moving direction (A) at the second decoration station (in particular, so as to center said at least one slab of compacted ceramic powder (KP) relative to the moving direction (A)).

21. The decoration method according to claim 16, further comprising:
a second detection step, which is prior to said first application step, and during which a second position detector detects at least one position (namely, orientation) of said at least one slab of compacted ceramic powder (KP) going into said first decoration station relative to the moving direction (A);
wherein, the second detection step comprises a second positioning sub-step, during which a second positioning device moves said at least one (in particular, each) slab of compacted ceramic powder (KP) going into said first decoration station so that said at least one (in particular, each) slab of compacted ceramic powder (KP) assumes a given position (orientation) relative to the moving direction (A) at said first decoration station (in particular, so as to center said at least one slab of compacted ceramic powder (KP) relative to the moving direction (A)).

22. The decoration method according to claim 16, wherein:
during said moving step, a plurality of slabs of compacted ceramic powder (KP) are moved along said given path (P) in the moving direction (A) (coming out) from said workstation up to said output station;
the decoration method comprises a coding step, which is prior to said drying step (in particular, also prior to said first and second application steps) and during which a writing device associates an identification code (in particular, a barcode or a Qrcode) with each slab of compacted ceramic powder (KP), and an identification step, which is at least partially prior to said synchronization step (in particular, simultaneous with said detection step) and during which a reading device reads the identification code associated with each slab of compacted ceramic powder (KP) and identifies it; and
during said synchronization step, said second printing assembly is operated (also) based on said identification code identified by said reading device during said identification step.

23. The decoration method according to claim 16, further comprising:
a final application step, which is subsequent to said third application step;
wherein, during the final application step, a fourth printing assembly, which is arranged downstream of said second printing assembly along said given path (P), applies a final layer comprising (in particular, consisting of) a coating material on said third layer so as to cover said defined decoration.

24. A decoration system for the decoration of a base ceramic article (CB), the decoration system comprising:
a conveyor device to convey at least one slab of compacted ceramic powder (KP) (in particular, a plurality of slabs of compacted ceramic powder (KP), each) having at least one surface to be decorated along a given path (P) in a moving direction (A), through at least a first decoration station and a second decoration station, which is arranged downstream of the first decoration station along said given path (P);
a first printing assembly, which is arranged at the first decoration station and is configured to apply a first layer comprising (in particular, consisting of) a first material, which comprises (in particular, is) an adhesive material, on at least part of said surface to be decorated of said at least one (in particular, each) slab of compacted ceramic powder (KP);
a first digital depositing assembly, which is arranged at the first decoration station downstream of said first printing assembly and is configured to selectively deposit a second layer comprising (in particular, consisting of) a least one granular material, which comprises granules and/or enamel atomized particles, on said first layer so that it adheres to said first layer and so as to form an at least partially relief pattern on said surface to be decorated of said at least one (in particular, each) slab of compacted ceramic powder (KP);
said first depositing assembly comprising at least one container, which is configured to contain said granular material and has an output mouth, whose longitudinal extension is transverse (in particular, perpendicular) to the moving direction (A), and a plurality of distribution elements, which are arranged in succession along the output mouth and can each be operated independently of the other ones so as to allow the granular material to go through at least an area of the output mouth where it is arranged;
a second printing assembly, which is arranged at the second decoration station and is configured to apply a third layer comprising (in particular, consisting of) ink and/or colored powder particles on said second layer so as to form a defined image on said at least partially relief pattern;
a dryer, which is arranged at a second workstation, downstream of said first decoration station and upstream of said second decoration station along said given path (P), and is configured to heat said at least one (in particular, each) slab of compacted ceramic powder (KP) having said at least partially relief pattern up to a temperature of at least circa 100° C. (in particular, of at least circa 150° C.; more in particular, up to a temperature of at least circa 180°):
a detection assembly, which is arranged and configured so as to detect said at least partially relief pattern formed on said surface to be decorated of said at least one (in particular, each) slab of compacted ceramic powder (KP);
a kiln, which is arranged at a third workstation downstream of said second decoration station along said given path (P) and is configured to cause said at least one (in particular, each) slab of compacted ceramic powder (KP) to have a temperature ranging from at least circa 1000° C. to at least circa 1300° C. (in particular, from at least circa 1150° C. to at least circa 1250° C.); and
a control assembly (CU), which is configured to operate (namely, control; in particular, in a digital manner) said second printing assembly based on the data detected by said detection assembly, so that said second printing assembly applies said defined image placing it, relative to said at least partially relief pattern, so as to generate a defined decoration on said surface to be decorated of said at least one (in particular, each) slab of compacted ceramic powder (KP).

25. The decoration system according to claim 24, further comprising:
a third printing assembly, which is arranged downstream of said first decoration station and upstream of said second decoration station;
wherein the third printing assembly applies a fourth layer comprising (in particular, consisting of) a coating material, in particular a liquid enamel or engobe, on said second layer.

26. The decoration system according to claim 24, wherein the detection assembly is arranged immediately downstream of said dryer along said given path (P) and comprises at least:
a first position detector to detect the position (namely, the orientation) of said at least one (in particular, each) slab of compacted ceramic powder (KP) relative to the moving direction (A) at said second decoration station; and
a structure detection device, which is configured to detect the structure of said at least partially relief pattern formed on said surface to be decorated.

27. The decoration system according to claim 26, further comprising:
at least one second position detector, which is arranged upstream of said first decoration station along said given path (P);
wherein the at least one second position detector is configured to detect a position (namely, an orientation) of said at least one slab of compacted ceramic powder (KP) at (namely, while going into) said first decoration station relative to the moving direction (A).

28. The decoration system according to claim 26, further comprising:
at least one positioning device (in particular, two positioning devices, each) configured to move said at least one (in particular, each) slab of compacted ceramic powder (KP) relative to the moving direction (A);
wherein said control assembly (CU) is configured to control said at least one positioning device (in particular, each positioning device) depending on the data detected by said first position detector (in particular, also by the second position detector) so that said at least one (in particular, each) slab of compacted ceramic powder (KP) assumes a given position (orientation) relative to the moving direction (A), to thereby center said at least one slab of compacted ceramic powder (KP) relative to the moving direction (A).

29. The decoration system according to claim 24, further comprising:
a writing device, which is arranged downstream of said first decoration station and is configured to associate an identification code (in particular, a barcode or a Qrcode) with said at least one slab of compacted ceramic powder (KP); and
a reading device upstream of the second decoration station, which reads the identification code associated with said at least one (in particular, each) slab of compacted ceramic powder (KP);
wherein said control assembly (CU) is configured to operate (namely, to control; in particular, in a digital manner) said second printing assembly (also) based on the data detected by said reading device.

30. The decoration system according to claim 24, wherein at least said first printing assembly and said second printing assembly (in particular, also said fourth printing assembly) each comprise (in particular, each consist of) an inkjet head to emit a material jet.
